(19) United States
(12) Patent Application Publication
(10) Pub. No.: US 2025/0158278 A1
(43) Pub. Date: May 15, 2025

(54) WIDEBAND WIDE SCAN PRINTED CIRCUIT BOARD ELEMENT FOR PHASED ARRAYS

(71) Applicant: MacDonald, Dettwiler and Associates Corporation, Sainte-Anne-de-Bellevue (CA)

(72) Inventors: Aiping Liang, Dollard-Des Ormeaux (CA); Karim Glâtre, Montreal (CA); Thomas Tralman, Whitby (CA)

(21) Appl. No.: 18/911,426

(22) Filed: Oct. 10, 2024

Related U.S. Application Data
(60) Provisional application No. 63/599,198, filed on Nov. 15, 2023.

(51) Int. Cl. H01Q 3/34; H01Q 1/52; H01Q 9/04

(52) U.S. Cl. CPC H01Q 3/34; H01Q 1/523; H01Q 9/045

(57) ABSTRACT

A unit cell for use in a phased array is provided. The unit cell includes: a printed circuit board (PCB) assembly comprising one or more PCB layers; a patch radiating element centrally disposed on a top surface of the PCB assembly; a plurality of EBG structures on the top surface of the PCB assembly, the EBG structures arranged around the patch radiating element, the EBG structures grounded in the PCB assembly; and a feed network embedded in the PCB assembly, the feed network in RF communication with the patch radiating element and for emitting or receiving an RF signal.

### TECHNICAL FIELD

The following relates generally to antenna systems, and more particularly to phased array elements in phased array antenna systems.

### INTRODUCTION

The use of printed circuit board (“PCB”) element technology in antenna systems is known. Typically, however, this technology has a very limited bandwidth.

A PCB antenna element offers a flat profile that will allow for a flat direct radiating array (DRA) with radiating elements on one face of the PCB and active electronics located on the opposite face. PCB antenna elements are typically narrow band and not compatible with standard satellite communication (“SatCom”) required bandwidth.

Accordingly, there is a need for an improved PCB phased array and array element therefor that overcome at least some of the disadvantages of phased arrays and phased array elements.

### SUMMARY

A unit cell for use in a phased array comprising a plurality of unit cells is provided. The unit cell includes: a printed circuit board (PCB) assembly comprising one or more PCB layers; a patch radiating element centrally disposed on a top surface of the PCB assembly; a plurality of EBG structures on the top surface of the PCB assembly, the EBG structures arranged around the patch radiating element, the EBG structures grounded in the PCB assembly; and a feed network embedded in the PCB assembly, the feed network in RF communication with the patch radiating element, the feed network for emitting or receiving an RF signal.

In an embodiment, at least some of the EBG structures are truncated such that, when arranged in an array next to an adjacent patch element, the truncated EBG structures of the first unit cell and the truncated EBG structures of the second unit cell together form at least one full non-truncated EBG structure.

In an embodiment, the EBG structures are arranged in at least two rows or rings around the patch radiating element.

In an embodiment, the unit cell further includes at least one electronic component or amplifier that serves the unit cell surface mounted to a bottom surface of the PCB assembly, the at least one electronic component or amplifier being contained entirely within a cross sectional volume of the PCB assembly.

In an embodiment, the unit cell further includes least one interface connector for connecting to at least one electronic component or amplifier external to the unit cell, the at least one interface connector disposed on a bottom surface of the PCB assembly.

In an embodiment, the EBG structures each comprise a patch element and a short circuit post centrally located on the patch element.

In an embodiment, the feed network provides circular polarization.

In an embodiment, the unit cell further includes one or more beamforming network components mounted to the bottom surface of the PCB assembly behind the patch radiating element.

In an embodiment, each EBG structure includes a patch element and a post connecting the patch element to a ground plane in the PCB assembly.

In an embodiment, the PCB assembly includes at least one ground plane and the patch radiating element includes a post connecting the patch radiating element to the ground plane.

In an embodiment, the PCB assembly includes at least two PCB layers that work as transmission lines to provide a hybrid connection between a beamforming network and the patch radiating element, and the PCB includes at least one additional layer that forms a radiating structure to emit or receive radiofrequency signals and periodic EBG to reduce a surface wave.

In an embodiment, the unit cell includes a plurality of probes disposed between first and second adjacent layers of the PCB assembly and one or more striplines and Wilkinson power dividers disposed between third and fourth adjacent layers of the PCB assembly.

In an embodiment, the EBG structures impede electromagnetic propagation along a top surface of the PCB assembly within a frequency band of operation of the unit cell.

In an embodiment, the at least one electronic component or amplifier is a solid state power amplifier.

In an embodiment, the at least one electronic component or amplifier is a low noise amplifier.

A phased array antenna including a plurality of unit cells of the present disclosure arranged in an array is also provided.

In an embodiment, the array is configured as a triangular lattice.

In an embodiment, the array is configured as a square lattice.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a perspective view of a wideband wide scan array element (or unit cell) for use in a phased array, according to an embodiment;

FIG. 1B is a partially transparent top view of the wideband wide scan array element of FIG. 1A, according to an embodiment;

FIG. 1C is a bottom view of the wideband wide scan array element of FIGS. 1A-1B illustrating a feed network, according to an embodiment; and

FIG. 2 is a top view of a sub array including a plurality of the wideband wide scan array elements of FIGS. 1A-1C, the subarray for use in a phased array, according to an embodiment; and

FIG. 3 is a top view of a full array including a plurality of the wideband wide scan array elements of FIGS. 1A-1C in a triangular lattice, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to phased arrays, and more particularly to a wideband wide scan PCB element for use in a phased array and phased arrays incorporating multiples of the wideband wide scan PCB elements. The wideband wide scan PCB element of the present disclosure is also referred to herein as a “phased array element”, “antenna element”, or “unit cell”.

While the unit cell of the present disclosure may be particularly well suited to use in an array, the unit cell may also be used as a single unit radiator. The unit cell includes an EBG structure, arranged around a patch radiating element, that acts as a high impedance for radiating currents. Accordingly, the unit cell of the present disclosure may find application in antennas where it is preferable to avoid current flow outside the antenna.

The phased array element may be particularly suitable for use in, for example, flat phased array antennas, synthetic aperture radar (“SAR”) elements, or OMNI antennas, and such applications are contemplated herein.

The phased array element of the present disclosure is based on PCB technology. PCB antenna elements advantageously provide a flat profile which can enable the design and use of flat direct radiating arrays (“DRAs”). In some cases, such flat DRAs may have an array of antenna elements on one face of the PCB and active electronics located behind the antenna elements on the opposite face of the PCB.

In an example embodiment, the antenna element covers the full Ku Transmit band (10.7 to 12.7 GHz) which represents roughly 18% bandwidth. This may be far more than existing PCB patch elements. The design of the antenna element is scalable to other bands such as, for example, Ka-Band.

The antenna element enables wideband PCB based flat DRAs that may reduce cost and improve the performance (e.g., active return loss, power consumption, etc.).

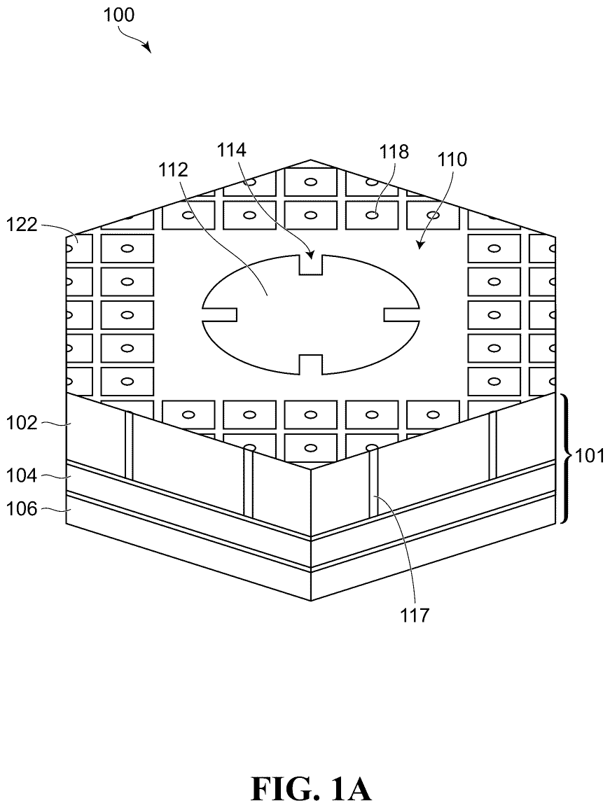

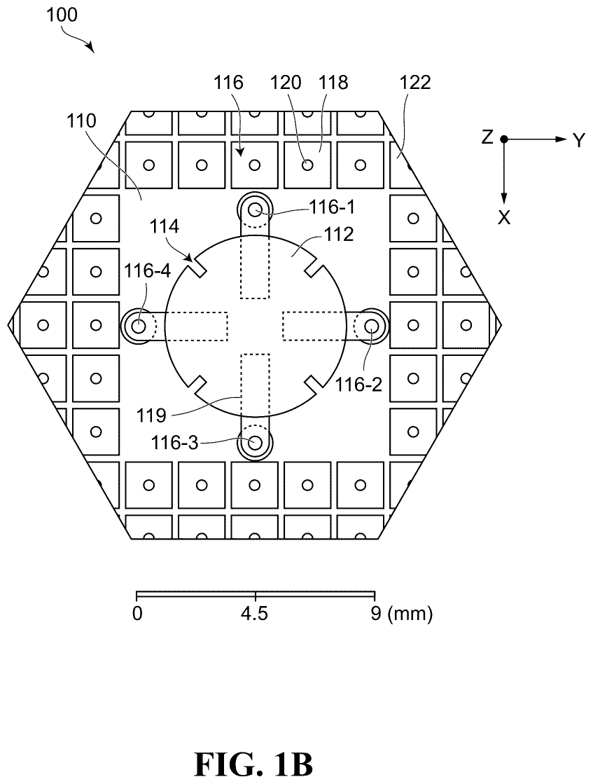

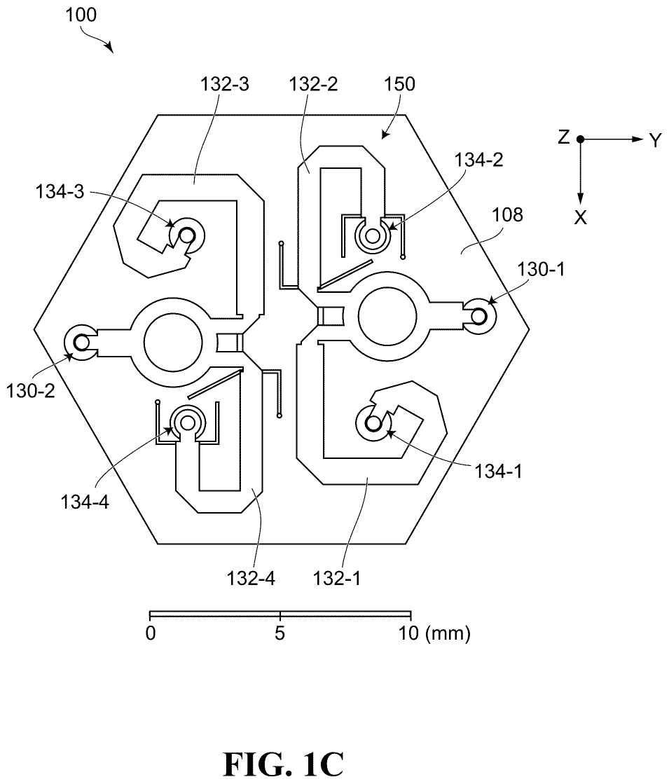

Referring now to FIGS. 1A-1C, shown therein are perspective, top, and bottom views, respectively, of a phased array element 100 (also referred to as unit cell 100, patch element 100, or antenna element 100), according to an embodiment.

The phased array element 100 may be used in an antenna onboard a spacecraft (e.g., satellite), an airborne platform, or may be used on a ground-based antenna.

In an embodiment, the phased array element 100 may be used in a low-profile or flat direct radiating array antenna.

The phased array element 100 may be configured for use in any RF frequency band. Non-limiting examples include Ku band, S band, Ka band, C band, and L band. In embodiments directed at lower frequencies (e.g., S band or C band), an array may be constructed with individual array elements 100 assembled together as “tiles”. Whether a certain frequency may be used may depend on factors such as geometry sizes, mass, and manufacturing tolerances. For embodiments directed at higher frequencies, a single PCB with all array elements (multiple instances of array element 100) may be used. In some embodiments, the phased array element 100 may be a unit cell of an array that includes amplifiers or other active components behind the unit cell, as a single unit cell, where the active components are contained entirely within the cross-sectional volume of the unit cell (e.g., for array element 100, the active components would be within the hexagonal cross sectional volume). Beamforming network components may be disposed behind the element on the other face of the PCB or on a separate PCB.

While phased array element 100 is shown as hexagonal, in other embodiments, phased array element 100 may have any other suitable shape or geometry and the shape or geometry is not particularly limited.

The phased array element 100 includes a layered PCB assembly 101 including a plurality of PCB layers 102, 104, 106.

First PCB layer 102 is disposed on the second PCB layer 104. Second PCB layer 104 is disposed on the third PCB layer 106.

While unit cell 100 includes three PCB layers (or four layers, if layer 102 includes two sublayers), other embodiments of the unit cell 100 may have other numbers of layers. The number of layers may be one or more, in some cases many more. An embodiment of one layer may be used for smaller RF bands, however, the feeding network, described below, would not be present.

The first and second layers 102, 104 and second and third layers 104, 106 may be bonded through fusion or a compatible prepreg.

The third PCB layer 106 (or bottom PCB layer 106) includes a bottom surface 108, which is the bottom surface of the element 100 and used to mount the phased array element 100. In some embodiments, the bottom surface 108 may be used to surface mount one or more electronic components of the antenna.

The first PCB layer 102 (or top PCB layer 102) includes a top surface 110, which is the top surface of the element 100. The top surface 110 may be referred to as a radiative surface of the phased array element 100.

The first PCB layer 102 contains a connection of the EBG structures 118 to ground.

The second and third PCB layers 104, 106 contain a feed network of the unit cell 100. Second PCB layer 104 includes a first part of the feed network and the third PCB layer 106 includes a second part of the feed network.

While phased array element 100 has three PCB layers, in other embodiments, the phased array element 100 may have fewer or additional layers. For example, in a phased array 100 implementing dual polarization, the number of PCB layers may be greater than three. In some cases, the number of PCB layers may be dictated by physical space available in the antenna.

The PCB layers 102, 104, 106 are hexagonally shaped. In other embodiments, the PCB layers may have other shapes or geometries. For example, the PCB layers may be triangular, rectangular, or octagonal.

The number of PCB layers may be set by the circuitry. For example, a patch element implementing dual polarization may have two layers for the feed network.

In an embodiment, the first PCB layer 102 may include at least two sublayers (not shown in FIGS. 1A-1C) disposed one on top of the other (i.e., a first/top sublayer and a second/bottom sublayer). The first and second sublayers may be physically separate PCBs. In an embodiment, EBG patches 116 and radiating element patch 112, described below, are disposed on top of the first sublayer of layer 102. Four probes are disposed between the first and second sublayers of layer 102. Stripline and Wilkinson power dividers are disposed between PCB layers 104 and 106. The unit cell 100 includes two ground planes. A first ground plane is disposed between the second sublayer of layer 102 and layer 104. A second ground plane is disposed at the bottom of layer 106. The unit cell 100 includes a post connecting the radiating element patch 112 to the ground in order to get rid of electrostatic discharge (ESD) in space. The unit cell 100 further includes a post connecting each EBG patch 118 (described below) to the ground.

PCB layers 104, 106 work as transmission lines to provide a hybrid connection between the beamforming network and radiating patches 112. Layers 102-1, 102-2 form a radiating structure to emit or receive the RF signals and periodic EBG to reduce the surface wave.

The phased array element 100 further includes a patch radiating element 112 disposed on top surface 110 of the first PCB layer 102. The patch radiating element 112 is positioned at the center of the first PCB layer 102.

The patch radiating element 112 may be a parasitic patch radiating element.

The patch radiating element 112 may be a dipole.

The patch radiating element 112 is connected to the feed network of the patch element 100, which is disposed behind the radiating element 112 in PCB layers 104, 106.

The patch radiating element 112 is generally circular with four notches 114 that are equally spaced about the perimeter of the circular radiating element 112. Notches 114 may be used to provide a better axial ratio of radiating circular polarization (CP) performance over a wide frequency band. Generally, performance in terms of axial ratio may dictate whether the patch radiating element 112 includes notches 114. In some embodiments, notches 114 may not be present.

While the radiating element 112 is depicted as circular, in other embodiments the radiating element 112 may have any suitable shape or geometry and its shape or geometry is not particularly limited. For example, the radiating element may be circular, rectangular, hexagonal, triangular, ring shaped, etc. The radiating element 112 may or may not have notches 114. For example, in another embodiment, the patch radiating element 112 may be a perfect circle.

In some embodiments, the patch radiating element 112 may include multiple patch radiating elements stacked or layered on each other. For example, the patch radiating element 112 may include a first patch radiating element disposed on top of (i.e., stacked on) a second patch radiating element. The first and second patch radiating elements may be different sizes (e.g., second patch radiating element having a larger area than the first patch radiating element on top). The first and second patch radiating elements may have the same shape/geometry or different shapes/geometries (e.g., a circular patch stacked on top of a larger rectangular patch).

In an embodiment, the patch element 100 may include an additional parasitic patch radiating element. In an embodiment, the patch element 100 may excite the patch radiating element and have an additional separate parasitic patch provide the polarization.

Referring now to FIG. 1B, the patch radiating element 112 includes input ports 116-1, 116-2, 116-3, 116-4 (referred to collectively as input ports 116 and generically as input port 116). The input ports 116 connect the radiating element 112 to the feed network 150. In variations, the number of input ports may vary. The input ports 116 are used to generate two polarizations. Using four ports 116 as shown in FIG. 1B, may result in the radiating element 112 giving the best radiating performance such as axial ratio (AR) and efficiency. However, the feed network becomes more complicated with four ports 116. In some embodiments, the number of probes feeding the patch radiating element 112 may be two.

There are four via connections between four rectangular probes 119 and striplines 132-1, 132-2, 132-3, 132-4 (shown in FIG. 1C). The large circles surrounding the vias in FIG. 1B are outer conductors of the coaxial feed circuit.

The phased array element 100 further includes a plurality of electromagnetic bandgap (“EBG”) structures 116 (referred to collectively as EBG structures 116 and generically as EBG structure).

The EBG structures 116, and EBGs more generally, are a class of metamaterials whose purpose is to highly impede electromagnetic propagation along the device's surface within the frequency band of operation known as “bandgap” (hence the name, “electromagnetic band gap” material). In this sense, the EBG 116 is an artificially high impedance surface and blocks current from flowing at microwave frequencies. In contrast, normal metals have very low impedance to current and allow current to flow over the entire metal surface.

The EBG structures 116 are disposed on the top surface of the first PCB layer 102. The EBG structures 116 are positioned around the radiating element 112 such that a row at least one EBG structure wide surrounds the patch radiating element 112.

Each EBG structure 116 includes a rectangular patch element 118 and a short circuit post 120 (or ground wire 120) located at the center of the rectangular patch element 118. In other embodiments, the patch element 118 may be a circle, hexagon, or any other suitable shape or geometry.

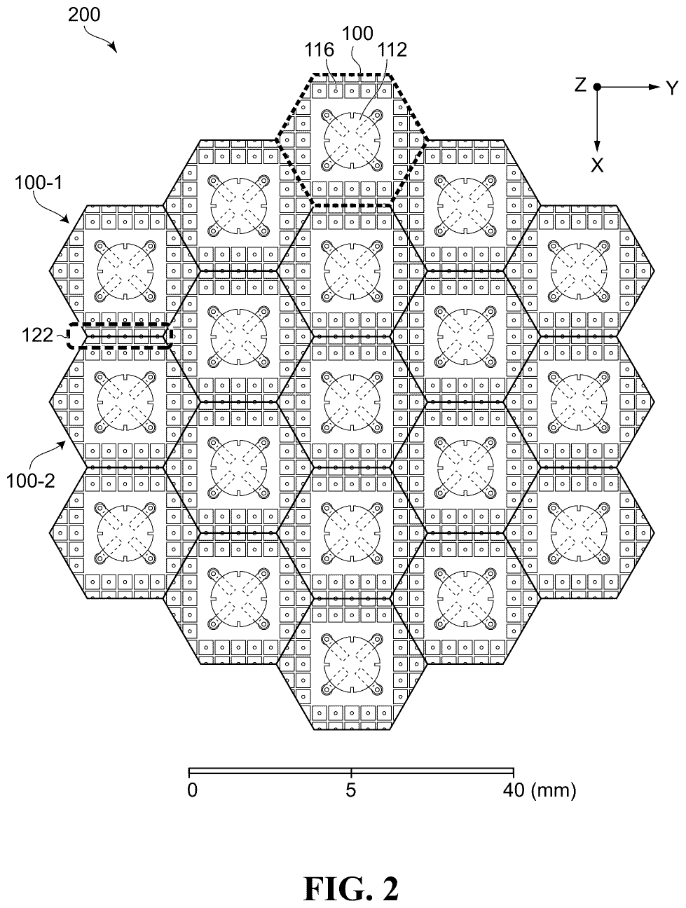

The phased array element 100 also includes truncated or partial EBG structures 122. Each truncated EBG structure 122 is configured to combine with an adjacent truncated EBG structure from an adjacent phased array element when the phased array element 100 and the adjacent phased array element are assembled in an array. An example is shown in FIG. 2, further described below. In embodiments, where the phased array element 100 is not part of an array, there may be no truncated EBG structures 122 (i.e., only whole EBG structures 116).

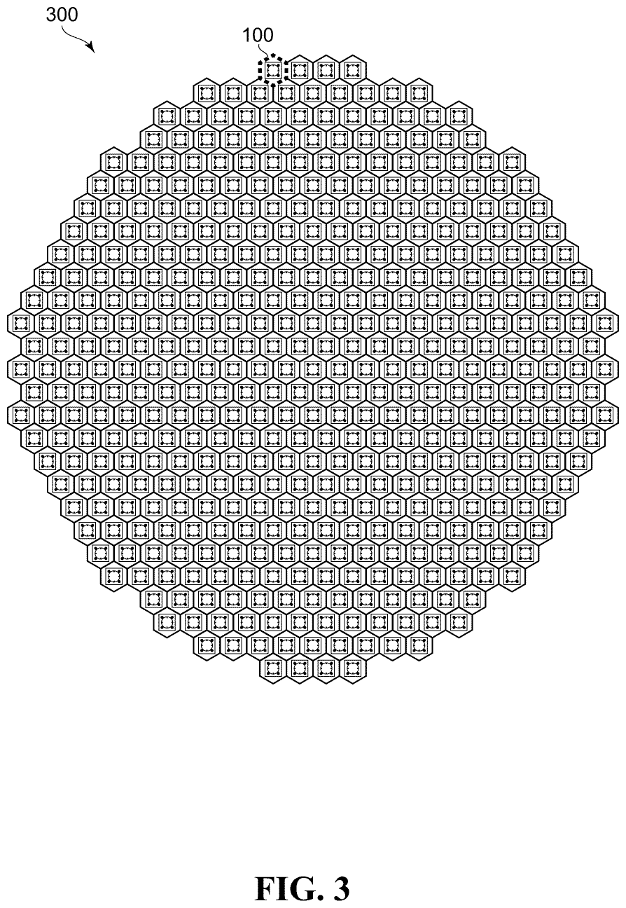

The need for truncated EBG structures 122 may arise depending on the geometry or shape of the phased array element 100, the EBG structure 116, and the array in which the phased array elements are assembled. For example, the phased array element 100 may be assembled into a triangular lattice array of phased array elements 100, such as in FIG. 2 and FIG. 3, which may require the truncation of certain EBG structures in a given phased array element 100 (and combination of those truncated elements when assembled into the array).

Truncated EBG structures 122 may also be referred to as intercell EBG structures, as they mate with other intercell EBG structures of adjacent phased array elements 100 to form a complete EBG structure 116.

The EBG structures 116 may be arranged in one or more layers or rows or rings around the radiating element 112. In a preferred embodiment, the number of layers or rows is more than one. When the phased array element 100 is to be assembled in an array, the number of rows may be the number of rows when the phased array element 100 is assembled in the array (i.e., including truncated EBG structures that have formed whole EBG structures with adjacent truncated EBG structures). In an embodiment, the number of rows or rings around the patch element 112 may be three. In another embodiment, the number of rows or rings around the patch element 112 may be four.

The EBG structures 116 provide a high impedance layer. The EBG structures 116 cut current going from one patch 112 to another patch. The EBG structures 116 form a resonator that cuts the currents flowing through the surface. The EBG structures 116 provide a high impedance surface for RF microwaves. The EBG structure 116 may function like a wire that is grounded in the PCB.

The EBG structures 116 reduce coupling. The EBG structures 116 allow for scanning on a wide angle of scan.

In some embodiments, the EBG structures 116 may advantageously also provide at least some radiation protection for at least one electronic component mounted on the back of the phased array element 100. The electronic component may be an SSPA or an LNA. The electronic component is mounted at the bottom of layer 106. Accordingly, the EBG structures 116 may provide a radiation shielding feature for electronic components in an array of phased array elements 100. Further, some layers of the PCB may be dedicated for shielding RF components.

The EBG structures 116 help drastically reduce the currents of a designed bandwidth, which improves the isolations and coupling between radiating elements 112.

The EBG structures 116 have the effect of attenuating the surface waves, which are an issue for PCB phased arrays when scanning at a wide angle (scan blindness).

Some EBG structures are adapted (truncated) in order to form a tile in a triangular lattice.

The phased array element 100 further includes posts 117. The posts 117 traverse from the top surface 110 of the first PCB layer 102 to the bottom surface (not visible) of the first PCB layer 102. Posts 117 connect the EBG patches 118 to the ground. Each EBG patch 118 has a post connected to the ground.

The phased array element 100 further includes a feed network 150. The feed network 150 is depicted in FIG. 1C. Feed network 150 is a nonlimiting example of a feed network that may be used in the phased array element 100, according to an embodiment.

The feeder network 150 is embedded within the PCB.

The feed network 150 may be configured to generate one polarization or two polarizations. The feed network 150 may generate circular polarization. The feed network 150 may generate linear polarization.

In the embodiment of FIG. 1C, the feed network 150 is single circular polarization. Four inputs are used to have symmetric excitation of the patch radiating element 112.

In some embodiments, the feed network 150 may have other functions (i.e., besides polarization) embedded therein. For example, the feed network 150 may include a filter component embedded therein.

In an embodiment, the feeding network 150 generates circular polarization is included in the element 100 and embedded in PCB layers 104, 106 behind the radiating element 112.

Unit cell 100 is directly connected to a (SSPA) or low noise amplifier (LNA) through two coaxial ports 130-1, 130-2. Circular polarization, right hand circular polarization (RHCP) or left hand circular polarization (LHCP), is obtained by changing the phases on the two ports 130-1, 130-2, 0° and 180° or 0° and −180°. Each port, 130-1 or 130-2, is split by a Wilkinson power divider into two outputs. The two outputs are connected to the two radiating probes through two striplines 132-1 and 132-2 or 132-3 and 132-4 and two coaxial ports 134-1 and 134-2 or 134-3 and 134-4.

In some embodiments, electronic components may be surface mounted to the phased array element 100. The electronic components or active components may include one or more SSPAs or LNAs. For example, one or more electronic or active components may be mounted on the back surface 108 of the phased array element 100. In some embodiments, the phased array element 100 may include one or more interface connectors for connecting to external electronics or amplifiers. For example, the one or more interface connectors may be disposed on surface 108 of the phased array element 100.

Referring now to FIG. 2, shown therein is a subarray 200 including a plurality of patch elements 100, according to an embodiment.

The number of patch elements 100 in this particular subarray 200 is 19. In other embodiments, the subarray 200 may include another number of patch elements 100. A representative patch element 100 is highlighted in FIG. 2, including radiating element 112 and EBG structures 116. The patch elements 100 are arranged in a triangular lattice. In other embodiments, subarray 200 may have other shapes or geometries.

As can be seen in FIG. 2, patch elements 100 are arranged in subarray 200 adjacent to one another such that truncated EBG structures 118 of adjacent patch elements 100 combine to form a non-truncated (full) EBG structure 116. An example of this is highlighted in FIG. 2 with adjacent truncated EBG structures 122 of patch elements 100-1 and 100-2 together forming full EBG structures 116.

In subarray 200, the isolation is better between the adjacent unit cells 100 because of the effect of the EBG structures 116. This makes each radiating cell have better axial ratio and remove scanning blindness. The subarray 200 may also improve port to port decoupling between adjacent radiating elements 112.

Referring now to FIG. 3, shown therein is a full array 300 of patch elements 100, according to an embodiment. The array 300 in FIG. 3 is a 256-element direct radiating array (DRA). In other embodiments, the number of elements in array 300 may be different.

The full array 300 is arranged as a triangular lattice. Having a triangular lattice can require closer spacing between individual unit cells 100 of the full array 300. In other embodiments, full array 300 may be another shape or have another geometry (e.g., square lattice of rectangular unit cells).

In other embodiments, a lattice having a geometry other than triangular may be used. For example, in a particular embodiment, the full array may be arranged as a square lattice.

The triangular lattice configuration of array 300 may be preferred as it may provide more elements per area of the DRA compared with, for example, a square lattice. For example, in an embodiment, the triangular lattice configuration provides 15% more elements in the same DRA area.

While the above description provides examples of one or more apparatus, methods, or systems, it will be appreciated that other apparatus, methods, or systems may be within the scope of the claims as interpreted by one of skill in the art.

1. A unit cell for use in a phased array comprising a plurality of unit cells, the unit cell comprising:
a printed circuit board (PCB) assembly comprising one or more PCB layers;
a patch radiating element centrally disposed on a top surface of the PCB assembly;
a plurality of EBG structures on the top surface of the PCB assembly, the EBG structures arranged around the patch radiating element, the EBG structures grounded in the PCB assembly; and
a feed network embedded in the PCB assembly, the feed network in RF communication with the patch radiating element, the feed network for emitting or receiving an RF signal.

2. The unit cell of claim 1, wherein at least some of the EBG structures are truncated such that, when arranged in an array next to an adjacent patch element, the truncated EBG structures of the first unit cell and the truncated EBG structures of the second unit cell together form at least one full non-truncated EBG structure.

3. The unit cell of claim 1, wherein the EBG structures are arranged in at least two rows or rings around the patch radiating element.

4. The unit cell of claim 1, further comprising at least one electronic component or amplifier that serves the unit cell surface mounted to a bottom surface of the PCB assembly, the at least one electronic component or amplifier being contained entirely within a cross sectional volume of the PCB assembly.

5. The unit cell of claim 1, further comprising at least one interface connector for connecting to at least one electronic component or amplifier external to the unit cell, the at least one interface connector disposed on a bottom surface of the PCB assembly.

6. The unit cell of claim 1, where the EBG structures each comprise a patch element and a short circuit post centrally located on the patch element.

7. A phased array antenna including an array of the unit cells of claim 1.

8. The phased array antenna of claim 7, wherein the array is configured as a triangular lattice.

9. The phased array antenna of claim 7, wherein the array is configured as a square lattice.

10. The unit cell of claim 1, further comprising one or more beamforming network components mounted to the bottom surface of the PCB assembly behind the patch radiating element.

11. The phased array antenna of claim 7, further comprising a beamforming network including a plurality of beamforming network components mounted to the bottom surface of the PCB assemblies of the unit cells in the array.

12. The unit cell of claim 1, wherein the feed network provides circular polarization.

13. The unit cell of claim 1, wherein each EBG structure includes a patch element and a post connecting the patch element to a ground plane in the PCB assembly.

14. The unit cell of claim 1, wherein the PCB assembly includes at least one ground plane and the patch radiating element includes a post connecting the patch radiating element to the ground plane.

15. The unit cell of claim 1, wherein the PCB assembly includes at least two PCB layers that work as transmission lines to provide a hybrid connection between a beamforming network and the patch radiating element, and wherein the PCB includes at least one additional layer that forms a radiating structure to emit or receive radiofrequency signals and periodic EBG to reduce a surface wave.

16. The unit cell of claim 1, further comprising a plurality of probes disposed between first and second adjacent layers of the PCB assembly and one or more striplines and Wilkinson power dividers disposed between third and fourth adjacent layers of the PCB assembly.

17. The unit cell of claim 1, wherein the EBG structures impede electromagnetic propagation along a top surface of the PCB assembly within a frequency band of operation of the unit cell.

18. The unit cell of claim 4, wherein the at least one electronic component or amplifier is a solid state power amplifier.

19. The unit cell of claim 4, wherein the at least one electronic component or amplifier is a low noise amplifier.
